(19) United States
(12) Patent Application Publication
(10) Pub. No.: US 2014/0272081 A1
(43) Pub. Date: Sep. 18, 2014

(54) Oils, Shortenings, and Compositions Thereof

(71) Applicant: The J.M. Smucker Company, Orrville, OH (US)

(72) Inventors: David Alan Volker, Cincinnati, OH (US); Joann Maxwell, Wadsworth, OH (US)

(73) Assignee: The J.M. Smucker Company, Orrville, OH (US)

(21) Appl. No.: 14/211,910

(22) Filed: Mar. 14, 2014

Related U.S. Application Data
(60) Provisional application No. 61/792,486, filed on Mar. 15, 2013.

(51) Int. Cl. A23D 9/00; A23G 3/34

(52) U.S. Cl. CPC A23D 9/00; A23G 3/343
USPC 426/606; 426/601; 426/613

(57) ABSTRACT

Oils shortenings, and compositions thereof are provided, each of which contain less than 0.5 wt. % trans fatty acids. The shortening composition includes is non-hydrogenated, non-interesterified vegetable oil, a non-hydrogenated, non-interesterified palm stearin, and mixtures thereof. Alternatively, the shortening composition includes a non-hydrogenated, interesterified vegetable oil. A food product containing the shortening composition is also provided.

### PRIORITY

The present patent application claims the benefit of U.S. Provisional Application No. 61/792,486, filed Mar. 15, 2013.

### TECHNICAL FIELD

The invention generally relates to oils, shortenings, and compositions thereof. More particularly, the invention relates to substantially trans-free oils, shortenings, and compositions thereof.

### BACKGROUND OF THE INVENTION

A number of food products, including frostings and baked products such as breads and cakes, require the inclusion of fats, such as shortenings, and/or fat-containing emulsions, such as margarines. Typically, shortening and margarine can provide structural characteristics to the food products, such as plasticity, dispersibility, and solid fat content profile, i.e., the percent solid fat present at different temperatures.

In the past, animal-based fats such as butter or lard were used in food applications that required a fat component. For a number of reasons, including availability and cost, shortenings and margarines have more recently been produced from vegetable oils. Since vegetable oils are typically liquids, they must be combined with or converted into a solid fat in order to have the structure characteristics and solid fat content profile that are required for functionality. A number of approaches have been employed for generating the solid fatty materials that have the desired solid fat content profile for a particular temperature range which may be required for a particular food processing operation. Two approaches that have been widely practiced in the past involved the partial hydrogenation of the vegetable oil, and mixing of the vegetable oil with additional solid fatty materials. These two approaches are well known among those skilled in the art of preparing fins and fat-containing emulsions such as shortenings and margarines.

The type of fats used in shortening and margarine compositions include saturated fatty acids and unsaturated fatty acids. Naturally occurring unsaturated fatty acids have carbon-carbon double bonds in a cis-configuration. The hydrogenation of unsaturated fatty acids to create partially hydrogenated fatty acids can result in isomerization with some of the cis-configured carbon-carbon double bonds in the unsaturated fatty acids are converted to the trans-configuration.

Until recently, these trans fatty acids were nutritionally categorized in the same way that the cis fatty acid starting materials are categorized, as unsaturated fatty acids, and they were not considered to have the demonstrated negative health consequences of the type which are typically associated with saturated fatty acids. However, a great deal of research has recently implicated trans fat in the development of cardiovascular disease. Thus, the National Academy of Medicine and many nutritionists have advised that consumption of trans fats should be limited, as much as possible, within the needs of a nutritionally adequate diet. Minimizing the presence of trans fatty acids in the diet will require that the technologically and economically advantageous practice of partial hydrogenation be eliminated or at least greatly reduced.

Therefore, there is a need for alternative fat compositions that can be substituted into currently used food formulations. Such fat compositions will need to contain only low levels or be free from trans fats, but they will also need to have acceptable functional properties including suitable melting profile, crystallization characteristics, shelf-life, and mouth-feel. It is particularly desirable to provide to the food industry fat compositions which are sufficiently low in trans fats to allow food manufacturers to advertise the low trans fat content of their products, such as by displaying or featuring a label claim or on the nutritional composition panel.

### SUMMARY OF THE INVENTION

In general, one aspect of the invention is to provide a shortening composition. The shortening composition comprises at least 73 wt. % of a first component including (i) a non-hydrogenated, non-interesterified vegetable oil, (ii) a non-hydrogenated, non-interesterified palm stearin, and (iii) mixtures thereof, at least 15 wt. % of a second component including a non-hydrogenated, non-interesterified vegetable oil having less than about 17% total saturated fatty acids, and at least one emulsifier.

In still yet another aspect of the invention, a shortening composition comprises non-hydrogenated, non-interesterified fats including about 37-43 wt. % palmitic acid, about 6-7 wt. % stearic acid, about 30-41 wt. % oleic acid, and about 9-1.9 wt. % linoleic acid.

In yet another aspect of the invention, a shortening composition comprises non-hydrogenated, non-interesterified fats including about 39-43 wt. % palmitic acid, about 6-7 wt. % stearic acid, about 30-32 wt. % oleic acid, and about 15-19 wt. % linoleic acid.

A further aspect of the invention includes a shortening composition comprising non-hydrogenated, non-interesterified fats including about 37-41 wt. % palmitic acid, about 6-7 wt. % stearic acid, about 38-4.1 wt. % oleic acid, and about 9-11 wt. % linoleic acid.

In still yet another aspect of the invention, a ready-to-spread (RTS) frosting is provided. The frosting comprises about 60-70 wt. % of at least one sweetener selected from the group consisting of sugar, powdered sugar, high maltose corn syrup, high fructose corn syrup, and mixtures thereof, about 15-25 wt. % of a shortening composition, wherein the shortening composition includes at least 73 wt. % of (i) a non-hydrogenated, non-interesterified vegetable oil, (ii) a non-hydrogenated, non-interesterified palm stearin, (iii) and mixtures thereof, at least 15 wt. % of a non-hydrogenated, non-interesterified vegetable oil having less than 17% total saturated fatty acids, and at least one emulsifier, about 10-25 wt. % water, at least one emulsifier, at least one starch, and at least one gum.

In yet another aspect of the invention, a ready-to-spread (RTS) frosting is provided. The frosting comprises about 35-45 wt. % of at least one sugar alcohol, about 20-30 wt. % of at least one bulking agent, about 0.05-0.10 wt. % of at least one high intensity sweetener, about 15-25 wt. % of a shortening composition, wherein the shortening composition includes at least 73 wt. % of a first component including (i) a non-hydrogenated, non-interesterified vegetable oil, (ii) a non-hydrogenated, non-interesterified palm stearin, and (iii) mixtures thereof, at least 15 wt. % of a second component including a non-hydrogenated, non-interesterified vegetable oil having less than 17% total saturated fatty acids, and at least one emulsifier, and about 5-10 wt. % water.

### DETAILED DESCRIPTION OF THE INVENTION

Unless otherwise defined, all technical and scientific terms used herein have the same meaning as is commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of ingredients, properties such as weight percent, reaction conditions, and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported with relative precision. Any numerical values, however, may inherently contain certain errors necessarily resulting from error found in their respective measurements.

In one embodiment of the invention, a shortening composition is disclosed and includes a fractionated vegetable oil, which is non-hydrogenated and non-interesterified, a non-hydrogenated, non-interesterified vegetable oil having less than 17% total saturated fatty acids, and at least one emulsifier. In another embodiment, a food product, such as a frosting, comprising the shortening composition is disclosed. In this form, the shortening composition may replace a partially hydrogenated shortening typically used in the food product. The shortening composition generally contains from low levels to substantially zero levels of trans-unsaturated fatty acids, and it is lower in saturated fatty acids than the shortening composition it is replacing.

The fractionated vegetable oil, which is non-hydrogenated and non-interesterified, is prepared from a fractionation process. The fractioning process of vegetable oils involves two main steps: crystallization and filtration. The three primary commercial processes for fractionating vegetable oil include the fast dry process, the slow dry process, and the detergent process. Each of these processes result in unique products having varying chemical properties and with different yields. During crystallization, different triglycerides in the vegetable oil melt at different temperatures. This difference in triglyceride melting points allows the liquid and solid oil components to be separated during the fractionation process. The character of the crystals produced depends on the temperature, time and agitation used during the process. The fractionated vegetable oil then passes through a filtration process, further dividing the oil into liquid vegetable olein, which includes various fatty acids, and solid vegetable stearin, which are primarily glycerol tristearate components. Since the liquid has been separated and filtered out, the fractionated vegetable oil which remains has a thicker texture and a higher viscosity. A higher percentage of saturated fat accounts for this additional thickness. In one embodiment, the fractionated vegetable oil is fractionated palm oil and comprises at least 73 wt. % of the shortening composition.

The fatty acids in the fractionated vegetable oil include, but are not limited to, stearic acid, palmitic acid, oleic acid, and linoleic acid. In one embodiment, the shortening composition includes about 43-50 wt. % palmitic acid, stearic acid, and mixtures thereof. In another embodiment, the shortening composition includes about 37-41 wt. % palmitic acid and about 6-7 wt. % stearic acid or about 39-43 wt. % palmitic acid and about 6-7 wt. % stearic acid. In still yet another embodiment, the shortening composition includes about 45-52 wt. % oleic acid, linoleic acid, and mixtures thereof. In still yet another embodiment, the shortening composition includes about 30-32 wt. % oleic acid and about 15-19 wt. % linoleic acid or about 38-41 wt. % oleic acid and about 9-11 wt. % linoleic acid.

Another component of the shortening composition is a non-hydrogenated, non-interesterified vegetable oil having less than 17% total saturated fatty acids. This vegetable oil includes, but is not limited to, sunflower oil, canola oil, soybean oil, peanut oil, olive oil, corn oil, and mixtures thereof. In one embodiment, the vegetable oil is soybean oil, canola oil, or mixtures thereof and comprises at least 15% of the shortening composition.

Yet another component of the shortening composition is at least one emulsifier. A wide variety of emulsifiers are suitable for use, including but not limited to mono- and diglycerides, distilled monoglycerides, polyglycerol esters of C₁₂ to C₂₂ fatty acids, propylene glycol mono and diesters of C₁₂ to C₂₂ fatty acids, sucrose mono- and diesters of C₁₄ to C₂₃ fatty acids. In one embodiment, the at least one emulsifier is Dimodan® HS K-A and comprises about 1-5 wt. % of the shortening composition.

In another embodiment, the shortening composition further comprises at least one antioxidant. A wide variety of antioxidants are suitable for use, including but not limited to butylated hydroxytoluene (BHT), butylated hydroxyanisole (BHA), tertiary butylhydroquinone (TBHQ), ethylenediaminetetracetic acid (EDTA), gallate esters (i.e. propyl gallate, butyl gallate, octyl gallate, dodecyl gallate, etc.), tocopherols, citric acid, citric acid esters (i.e. isopropyl citrate, etc.), gum guaiac, nordihydroguaiaretic acid (NDGA), thiodipropionic acid, ascorbic acid, ascorbic acid esters (i.e. ascorbyl palmitate, ascorbyl oleate, ascorbyl stearate, etc.) tartaric acid, lecithin, methyl silicone, and mixtures thereof. Another antioxidant suitable for use in the shortening composition includes Grindox® 497, which is a blend of 10% mixed natural tocopherols, 10% ascorbyl palmitate, and 80% carrier oil, the carrier oil being a blend of soybean oil and lecithin. Yet another antioxidant suitable for use in the shortening composition includes Guardian™ Chelox L, which is a plant extract in a propylene glycol carrier. Suitable plant extracts include, but are not limited to, rosemary, sage, oregano, thyme, chamomile, marjoram, and mixtures thereof. In one embodiment, the shortening composition includes about 0.01-0.1 wt. % of at least one antioxidant.

In yet another embodiment, the shortening composition may further comprise one or more additives. Common additives that can be added to the shortening compositions provided herein include, but are not limited to, stabilizers, flavoring agents, anti-spattering agents, and colorants.

The shortening composition, as described above, has a unique Solid Fat Content (SFC) profile. The SFC is the standardized analysis of fats and oils which is generally accepted in the food industry. Direct measurements of SFC by Nuclear Magnetic Resonance (NMR) spectroscopy can be performed quickly and accurately according to the AOCS Cd 16b-93 standard. The SFC profile determination by NMR is based on measuring the direct ratio between the solid and liquid parts of the sample, as observed in the NMR free induction decay (FID), after excitation of the sample by 90° radiofrequency pulse FID is detected. The FID is the signal accompanying the spin relaxation process which takes place as the hydrogen protons magnetic spins move back to an equilibrium state after they are disturbed by the RF pulse. The information contained in the FID comes from contributions from both solid and liquid parts of the sample. The proton spins associated with the liquid content of the sample relax back to equilibrium much more slowly than those proton spins associated with the solid phase component. Thus, a long lasting signal is observed for protons in the liquid phase, and a rapid decaying signal is observed for protons in the solid-phase. The SFC value can be determined by comparing two measurement points on the FID including the FID amplitude at point S (corresponding to total solids plus liquids), and at point L (corresponding to liquids only). An F-factor (f) allows the prediction of the FID amplitude value immediately after RF pulse, which is impossible to observe directly due to dead-time of the receiver and the ringing time of the probe. The F-factor is used to increase the accuracy of the measurement and it can be determined during the calibration procedure. The specific ratio can be found by using equation (1):

SFC=(f*S−L)/f*S (1)

The S:L amplitude ratio of equation (1) is considered to be the SFC value. The process for determining the SFC value is performed at different temperatures in order to observe the different relaxation times of the solid and liquid parts of the sample at the different temperatures and this temperature dependence behavior is referred to as the SFC profile.

The SFC profile for embodiments of the shortening composition and which include the non-hydrogenated, non-interesterified vegetable oil are about 47-53% at 10° C., and 28-32% at 20° C., and 9-11% at 40° C.

In an alternate embodiment of the invention, a shortening composition is disclosed and includes a non-hydrogenated, interesterified vegetable oil. The interesterified containing shortening composition also includes a non-hydrogenated, non-interesterified vegetable oil having less than 17% total saturated fatty acids, and at least one emulsifier.

The non-hydrogenated, interesterified vegetable oil is prepared through the process of interesterification. The interesterification of vegetable oils is a process often used to increase the solidity of a fat without having to undergo partial hydrogenation. Interesterification can be used to combine fatty acids of a liquid vegetable oil with a fully hydrogenated fat to create a trans-free fat solution. This allows the liquid oil and the solid fat to be combined in a more permanent way where they can now take on a true combined function. The interesterification process does not change the nutritional profile of the product. Rather, it simply causes a redistribution of the fatty acids on the glycerol backbone. This process is facilitated by either chemical or enzymatic means. Both the chemical and enzymatic interesterification processes rearrange the fatty acids across the glycerol backbone of the triglyceride and, after separating the fatty acid components from their original glycerol backbone, the fatty acid molecules can be reconfigured anew and any three of the following fatty acids can be recombined (Omega 3, Omega 6, Omega 9, or fully saturated fatty acids) onto a new glycerol backbone, in order to achieve the desired hardness of the end product. In one embodiment, the interesterified vegetable oil is an interesterified palm oil and comprises at least 30 wt. % of the shortening composition.

The fatty acids in the non-hydrogenated, interesterified vegetable oil include, but are not limited to, stearic acid, palmitic acid, oleic acid, and linoleic acid. In one embodiment, the shortening composition includes about 30-39 wt. % palmitic acid, stearic acid, and mixtures thereof. In another embodiment, the shortening composition includes about 25-30 wt. % palmitic acid and about 7-9 wt. % stearic acid or about 24-27 wt. % palmitic acid and about 6-8 wt. % stearic acid. In still yet another embodiment, the shortening composition includes about 42-55 wt. % oleic acid, linoleic acid, and mixtures thereof. In another embodiment, the shortening composition includes about 13-17 wt. % oleic acid and about 29-35 wt. % linoleic acid or about 38-42 wt. % oleic acid and about 10-13 wt. % linoleic acid.

Another component of the shortening composition is a non-hydrogenated, non-interesterified vegetable oil having less than 17% total saturated fatty acids. This vegetable oil includes, but is not limited to, sunflower oil, canola oil, soybean oil, peanut oil, olive oil, corn oil, and mixtures thereof. In one embodiment, the vegetable oil is soybean oil, canola oil, or mixtures thereof and comprises at least 50% of the shortening composition.

Yet another component of the shortening composition is at least one emulsifier. A wide variety of emulsifiers are suitable for use, including but not limited to mono- and diglycerides, distilled monoglycerides, polyglycerol esters of C₁₂ to C₂₂ fatty acids, propylene glycol mono and diesters of C₁₂ to C₂₂ fatty acids, sucrose mono- and diesters of C₁₄ to C₂₂ fatty acids. In one embodiment, the shortening composition comprises about 1-5 wt. % emulsifier, which is Dimodan® HS K-A.

In another embodiment, the shortening composition further comprises at least one antioxidant. A wide variety of antioxidants are suitable for use, including but not limited to butylated hydroxytoluene (BHT), butylated hydroxyanisole (BHA), tertiary butylhydroquinone (TBHQ), ethylenediaminetetracetic acid (EDTA), gallate esters (i.e. propyl gallate, butyl gallate, octyl gallate, dodecyl gallate, etc.), tocopherols, citric acid, citric acid esters (i.e. isopropyl citrate, etc.), gum guaiac, nordihydroguaiaretic acid (NDGA), thiodipropionic acid, ascorbic acid, ascorbic acid esters (i.e. ascorbyl palmitate, ascorbyl oleate, ascorbyl stearate, etc.) tartaric acid, lecithin, methyl silicone, and mixtures thereof. Another antioxidant suitable for use in the shortening composition includes Grindox® 497, which is a blend of 10% mixed natural tocopherots, 10% ascorbyl palmitate, and 80% carrier oil, the carrier oil being a blend of soybean oil and lecithin. Yet another antioxidant suitable for use in the shortening composition includes Guardian™ Chelox L, which is a plant extract in a propylene glycol carrier. Suitable plant extracts include, but are not limited to, rosemary, sage, oregano, thyme, chamomile, marjoram, and mixtures thereof. In one embodiment, the shortening composition includes about 0.01-0.1 wt. % of at least one antioxidant.

In yet another embodiment, the shortening composition may further comprise one or more additives. Common additives that can be added to the shortening compositions provided herein include, but are not limited to, stabilizers, flavoring agents, anti-spattering agents, and colorants.

The SFC profile for embodiments of the shortening composition, which include the non-hydrogenated, interesterified vegetable oil are about 42-46% at 10 and 30-36% at 20 and 9-11% at 40 T.

The following Tables and Examples illustrate the components, as well as amounts, of various representative shortening compositions according to the embodiments described herein. These Tables are to be construed as merely illustrative, and not limitative of the remainder of the disclosure in any way whatsoever.

TABLE 1
Exemplary Shortening Compositions Containing
Fractionated Vegetable Oil

| | Example 1 | | Example 2 | |
|---|---|---|---|---|
| | Wt. % Range | Wt. % | Wt. % Range | Wt. % |
| Ingredient | | | | |
| Soybean Oil | 19-21 | 19.99 | 0 | 0 |
| Canola Oil | 0 | 0.00 | 19-21 | 19.99 |
| Fractionated | 73-81 | 76.95 | 73-81 | 76.95 |
| Vegetable Oil | | | | |
| Emulsifier | 1-5 | 3.0 | 1-5 | 3.0 |
| Antioxidant #1 | 0.01-0.1 | 0.05 | 0.01-0.1 | 0.05 |
| Antioxidant #2 | 0.01-0.1 | 0.05 | 0.01-0.1 | 0.05 |
| Fatty Acid Content | | | | |
| C12:0 | 0.10-0.20 | 0.18 | 0.10-0.20 | 0.18 |
| C14:0 | 0.50-1.0 | 0.89 | 0.50-1.0 | 0.88 |
| C16:0 | 39-43 | 40.69 | 37-41 | 39.21 |
| C18:0 | 6-7 | 6.67 | 6-7 | 6.22 |
| C20:0 | 0.25-0.50 | 0.36 | 0.25-0.50 | 0.41 |
| C22:0 | 0.10-0.15 | 0.12 | 0.10-0.15 | 0.12 |
| C16:1 | 0.1-0.2 | 0.15 | 0.1-0.2 | 0.18 |
| C18:1 | 30-32 | 31.41 | 38-41 | 39.88 |
| C18:2 | 15-19 | 17.14 | 9-11 | 10.11 |
| C18:3 | 1.5-2.0 | 1.62 | 1.5-2.0 | 1.78 |
| C20:1 | 0.1-0.2 | 0.18 | 0.25-0.75 | 0.41 |
| Solid Fat Content | | | | |
| 10° C. | 47-53 | 49.12 | 47-53 | 49.68 |
| 20° C. | 28-32 | 30.11 | 28-32 | 31.05 |
| 40° C. | 9-11 | 9.95 | 9-11 | 9.86 |

TABLE 2
Exemplary Shortening Compositions Containing
Interesterified Vegetable Oil

| | Example 3 | | Example 4 | |
|---|---|---|---|---|
| | Wt. % Range | Wt. % | Wt. % Range | Wt. % |
| Ingredient | | | | |
| Soybean Oil | 53-60 | 57.94 | 0 | 0 |
| Canola Oil | 0 | 0 | 53-60 | 57.94 |
| Interesterified | 33-39 | 36.0 | 33-39 | 36.0 |
| Vegetable Oil | | | | |
| Hydrogenated Palm | 1.0-5.0 | 3.0 | 1.0-5.0 | 3.0 |
| Oil | | | | |
| Emulsifier | 1-5 | 3.0 | 1-5 | 3.0 |
| Antioxidant #1 | 0.01-0.1 | 0.05 | 0.01-0.1 | 0.05 |
| Antioxidant #2 | 0.01-0.1 | 0.01 | 0.01-0.1 | 0.01 |
| Fatty Acid Content | | | | |
| C12:0 | 4-8 | 6.11 | 3-6 | 4.87 |
| C14:0 | 1-5 | 3.06 | 1-4 | 2.44 |
| C16:0 | 25-30 | 28.63 | 24-27 | 25.51 |
| C18:0 | 7-9 | 7.86 | 6-8 | 7.05 |
| C20:0 | 0.1-0.5 | 0.32 | 0.25-0.75 | 0.49 |
| C22:0 | 0.1-0.5 | 0.25 | 0.25-0.75 | 0.49 |
| C16:1 | 0.01-0.1 | 0.06 | 0.1-0.2 | 0.16 |
| C18:1 | 13-17 | 15.66 | 38-42 | 40.53 |
| C18:2 | 29-35 | 32.81 | 10-13 | 12.03 |
| C18:3 | 3-6 | 4.5 | 4-6 | 5.04 |
| C20:1 | 0.1-0.5 | 0.23 | 0.5-1.5 | 0.93 |
| Solid Fat Content | | | | |
| 10° C. | 42-46 | 43.98 | N/A | N/A |
| 20° C. | 30-36 | 33.15 | N/A | N/A |
| 40° C. | 9-11 | 9.42 | N/A | N/A |

In another embodiment, a food product, such as a frosting, comprising the shortening composition as disclosed herein, is disclosed.

Described herein are exemplary ready-to-spread (“RTS”) frostings, which in one embodiment, includes sugar, and in another embodiment is sugar-free. Unless otherwise indicated, the term “sugar-free” as used herein is selected from the group consisting on (a) a frosting comprising less than about 2 percent shortening weight basis sugar; (b) a frosting having substantially no sugar added to the product, i.e., no sugar added as a separate ingredient; (c) less than 0.5 g sugar per 30 g serving of the frosting, i.e., less than 0.5 g sugar per 30 g serving of the frosting; and (d) combinations thereof. Sugar, as referred to herein, includes any sucrose, lactose, maltose, fructose, glucose, galactose, or combination thereof. Moreover, exemplary sugar-free RTS frostings described herein have less sugar than that of the “sugar-free” definition provided above, i.e., less than the 0.5 g per 30 g serving. The exemplary sugar-free frostings have less than 0.3 g sugar per 30 gram serving of the frosting. Exemplary sugar-free RTS frostings herein use a combination of sugar alcohols, high intensity sweeteners, sweetness flavor enhancers, and bulking agents to replace the original sugar content as the primary ingredient and still have comparable organoleptic attributes with respect to full-sugar conventional RTS frostings.

The ready-to-spread frostings described herein comprise water, sugar or sugar alcohols, bulking agents, flavorants, emulsifiers, and the shortening composition as described herein which includes the fractionated vegetable oil, as previously described and, in alternate embodiments, the interesterified vegetable oil as previously described. The frostings may also optionally include any one or more of the following: sweeteners, viscosity agents, sweetness flavor enhancers, and high intensity sweeteners. The amounts of each of the ingredients discussed herein are the ranges included in the final RTS frosting, unless noted otherwise. All amounts are given in percentages, by weight.

The shortening composition may be included in the frostings described herein at levels from about 15 wt. % to about 25 wt. %. In some embodiments, the shortening composition is from about 1.5 wt. % to about 22 wt. % of the sugar-containing frosting and from about 18 wt. % to about 22 wt. % of the sugar-free frosting.

Sugar alcohols included in the sugar-free frosting are in the range from about 25 wt. % to 50 wt. %. While total amount of the sugar alcohol generally falls within this range, it may be adjusted depending on which particular sugar alcohol or combination of sugar alcohols is used. Sugar alcohols that may be used include, but are not limited to maltitol, sorbitol, glycerin, isomalt, erythritol, mannitol, xylitol, lactitol, hydrogenated starch hydrosylates, tagatose, trehalose and combinations thereof. Preferred sugar alcohols include isomalt, maltitol, sorbitol, and combinations thereof.

Bulking agents are added to the frostings described herein at a level of about 10 wt. % to about 30 wt. %. Some bulking agents that may be used include, but are not limited to polydextrose, maltodextrin, cellulose powder (e.g., SOLKA-FLOC® brand cellulose powder, available from International Fiber Corp.), inulin, whey protein concentrate, specially modified starches, and combinations thereof. In one embodiment a 70% polydextrose solution is used as the bulking agent. Other embodiments include using maltodextrin having a dextrose equivalence (DE) of 5, (e.g., maltodextrin 5DE, such as STAR-DRI® 5 maltodextrin, available from Tate & Lyle), as a bulking agent.

Flavorants may be added in a flavor-enhancing amount. The amount added will depend on the particular flavorant and may be determined by those of ordinary skill in the art. Flavorants may include both natural flavorants and artificial flavorants. Some flavorants that may be used include vanilla, chocolate liquor, fudge, fruit flavors, chocolate, milk chocolate, coconut, pecan, lemon, cream cheese, French vanilla, chocolate cream cheese, strawberry, walnut, almond, and so forth, and combinations thereof. Flavorants may be added in ranges conventionally used when preparing frostings including from about 0.1 wt. % to about 1.0 wt. %. The amount of a particular flavorant added may be readily determined by those of ordinary skill in the art. For a milk chocolate or a chocolate fudge frosting, cocoa may be added in the range from about 2 wt. % to about 7 wt. %. Salt may be added in a flavor-enhancing amount. Optionally, colorants may be added to the frostings described herein. Conventional food coloring agents may be used. The amounts used depend on the desired end color of the frosting and may be determined by those of ordinary skill in the art.

Emulsifiers are included in the frostings described herein in amounts depending on the identity of the emulsifier. Mono- and diglycerides can be included at levels from about 0.5 wt. % to about 3 wt. %. Alternatively, distilled monoglycerides, or combinations or mono- and diglycerides and distilled monoglycerides may be used. Alternatively, or in addition, polysorbate 60, polysorbate 80, sodium caseinate, sodium stearyl lactylate, diacetyl tartaric acid esters of mono- and diglycerides (e.g., DATEM), propylene glycol monostearate, polyglycerol esters of fatty acids and combinations thereof may be added at levels in the range from about 0.1 wt. % to about 0.5 wt. %. Soy lecithin or other lecithins may optionally be added at levels up to 0.15 wt. %.

In the sugar-containing frostings, the source of the sugar includes, but is not limited to, monosaccharides and disaccharides, which can include glucose, fructose, sucrose, maltose, lactose in either liquid or powder form and are added at levels from about 45 wt. % to about 60 wt. %.

In the sugar-free frostings, high intensity sweeteners, including sucralose, aspartame, acesulfame potassium, saccharin, neotame, and the like, and combinations thereof, may optionally be added at levels from about 0.05 wt. % to about 0.15 wt. %.

Sweetness flavor enhancers may optionally be added to the sugar-free frostings described herein to enhance the perception of sweetness. An embodiment of a sweetness flavor enhancer is a maltodextrin carrier blended with natural flavor ingredients that combines in a synergistic effect with the sugar alcohols and/or high intensity sweeteners described herein to enhance the sweetness flavor. An example of a sweetness flavor enhancer is Sweet Lift™ available from Wixon, Inc. The sweetness flavor enhancer can be added at levels from about 0.05 wt. % to about 0.15 wt. %.

Viscosity agents may optionally be included in the frostings described herein. The amount of the viscosity agent added depends on the viscosity agents used. Starches, such as modified corn starch, wheat starch (including pregelatinized wheat starch), potato starch, rice starch, tapioca starch, and combinations thereof may be added at levels from 0.1 wt. % to about 0.5 wt. %. Other viscosity agents, such as blends of cellulose gel and cellulose gum, blends of microcrystalline cellulose and sodium carboxymethyl cellulose (“Na-CMC”), pectin, carrageenan, agar, gellan gum, alginates, gum acacia, gelatin, methyl cellulose, hydroxypropylcellulose, and combinations thereof may be added at levels in the range from 0.1 wt. % to about 1.0 wt. %. Still other viscosity agents, such as xanthan gum, locust bean gum, guar gum, tragacanth karaya, and combinations thereof may be added at levels from 0.01 wt. % to about 0.1 wt. %. In other embodiments, certain viscosity agents that may be added include an icing stabilizer blend of a combination of fiber, gum, and sucrose may be added at levels in the range from about 0.5 wt. % to about 1.5 wt. %. An example such icing stabilizer blend is a blend of about 50-80 wt. % citrus pulp, 5-25 wt. % guar gum, and about 5-25 wt. % sucrose (e.g. CitriTex™ available from Cargill, Inc.).

Water is added to the frosting in the range from about 5 wt. % to about 20 wt. %, preferably in the range from about 8 wt. % to about 18 wt. %. In certain embodiments, deionized water is used.

Optionally, other additives may also be present in the frostings described herein in varying amounts. This includes, but is not limited, to preservatives, acidulants, and mixtures thereof.

The following Tables and Examples illustrate the components, as well as amounts, of various representative frosting compositions according to the embodiments described herein. These Tables are to be construed as merely illustrative, and not limitative of the remainder of the disclosure in any way whatsoever.

TABLE 3
Representative Sugar-Containing Ready-To-Spread Frosting
With Shortening Composition Containing Fractionated Vegetable Oil
Example 5

| Ingredient | Wt. % Range |
|---|---|
| Sugar | 45-60 |
| Shortening | 15-22 |
| Bulking Agents | 10-30 |
| Water | 5-20 |
| Viscosity Agents | 0.1-1.0 |
| Emulsifiers | 0.5-3.0 |
| Flavorants | 0.1-1.0 |

TABLE 4
Representative Sugar-Free Ready-To-Spread Frosting
With Shortening Composition Containing Fractionated Vegetable Oil
Example 6

| Ingredient | Wt. % Range |
|---|---|
| High Intensity Sweetener | 0.05-0.15 |
| Sweetness Enhancer | 0.05-0.15 |
| Sugar Alcohols | 25-50 |
| Water | 5-20 |
| Shortening | 18-22 |
| Bulking Agents | 10-30 |
| Viscosity Agents | 0.1-1.0 |
| Emulsifiers | 0.5-3.0 |
| Flavorants | 0.1-1.0 |

TABLE 5
Exemplary Creamy Ready-To-Spread Frosting With
Shortening Composition Containing Fractionated Vegetable Oil
Example 7

| Ingredient | Wt. % |
|---|---|
| Powdered Sugar | 56.73 |
| Corn Starch | 1.66 |
| High Maltose Corn Syrup | 10.95 |
| Shortening Composition | 16.28 |
| Water | 12.67 |
| Modified Corn Starch | 0.25 |
| Xanthan Gum | 0.03 |
| Polysorbate 60 | 0.18 |
| Lecithin | 0.06 |
| One of more of the following additives: Salt, | 1.19 |
| Potassium Sorbate, Titanium Dioxide, Citric | |
| Acid, Vanilla Flavor, and Colorant | |

TABLE 6
Exemplary Whipped Ready-To-Spread Frosting With
Shortening Composition Containing Fractionated Vegetable Oil
Example 8

| Ingredient | Wt. % |
|---|---|
| Powdered Sugar | 53.72 |
| High Maltose Corn Syrup | 8.98 |
| Shortening Composition | 21.07 |
| Water | 14.00 |
| Carrageenan | 0.20 |
| Emulsifier Blend | 0.35 |
| Polysorbate 80 | 0.15 |
| One of more of the following | 1.53 |
| additives: Salt, Potassium | |
| Sorbate, Titanium Dioxide, | |
| Citric Acid, Vanilla Flavor, | |
| Colorant, and Cellulose Gel | |

TABLE 7
Exemplary Sugar-Free Ready-To-Spread Frosting With
Shortening Composition Containing Fractionated Vegetable Oil
Example 9

| Ingredient | Wt. % |
|---|---|
| Sucralose | 0.07 |
| Sweetness Enhancer | 0.07 |
| Shortening Composition | 20.29 |
| Water | 9.23 |
| Modified Corn Starch | 1.00 |
| Sorbitol Solution 70% | 13.21 |
| Malitol Syrup 75% | 16.23 |
| Polydextrose Solution 70% | 13.29 |
| Isomalt | 11.13 |
| Maltodextrin | 10.12 |
| Stabilizer Blend | 1.20 |
| Cellulose | 2.53 |
| Polysorbate 80 | 0.18 |
| Lecithin | 0.06 |
| One of more of the following | 1.39 |
| additives: Salt, Potassium | |
| Sorbate, Titanium Dioxide, | |
| Citric Acid, Vanilla Flavor, | |
| Colorant | |

Based upon the foregoing disclosure, it should now be apparent that the shortening compositions and food products, such as ready-to-spread frostings, prepared with these shortening compositions as described herein will carry out the objects set forth hereinabove. It is, therefore, to be understood that any variations evident fall within the scope of the claimed invention and thus, the selection of specific component elements can be determined without departing from the spirit of the invention herein disclosed and described.

### Exemplary Embodiments

Exemplary embodiments of the invention include, but are not limited to:
1. A shortening composition comprising:

at least 30 wt. % of a non-hydrogenated, interesterified vegetable oil;

at least 50 wt. % of a non-hydrogenated, non-interesterified vegetable oil having less than 17% total saturated fatty acids; and

at least one emulsifier.

2. The shortening composition of embodiment 1, wherein about 33-39 wt. % of the shortening composition includes the non-hydrogenated, interesterified vegetable oil.
3. The shortening composition of embodiment 1, wherein about 53-60 wt. % of the shortening composition includes the non-hydrogenated, non-interesterified vegetable oil having less than 17% total saturated fatty acids
4. The shortening composition of embodiment 1, wherein the shortening composition includes about 30-39 wt. % palmitic acid, stearic acid, and mixtures thereof.
5. The shortening composition of embodiment 4, wherein the shortening composition includes about 25-30 wt. % palmitic acid and about 7-9 wt. % stearic acid.
6. The shortening composition of embodiment 4, wherein the shortening composition includes about 24-27 wt. % palmitic acid and about 6-8 wt. % stearic acid.
7. The shortening composition of embodiment 1, wherein the shortening composition includes about 42-55 wt. % oleic acid, linoleic acid, and mixtures thereof.
8. The shortening composition of embodiment 7, wherein the shortening composition includes about 13-17 wt. % oleic acid and about 29-35 wt. % linoleic acid.
9. The shortening composition of embodiment 7, wherein the shortening composition includes about 38-42 wt. % oleic acid and about 10-13 wt. % linoleic acid.
10. The shortening composition of embodiment 1, wherein the shortening composition includes less than 0.5 wt. % trans fatty acids.
11. A shortening composition comprising:

non-hydrogenated, interesterified fats including about 26-30 wt. % palmitic acid, about 6-8 wt. % stearic acid, about 14-17 wt. % oleic acid, and about 29-35 wt. % linoleic acid.

12. The shortening composition of embodiment 11, wherein the shortening composition includes less than 0.5 wt. % trans fatty acids.
13. A ready-to-spread (RTS) frosting comprising:

about 60-70 wt. % of at least one sweetener selected from the group consisting of sugar, powdered sugar, high maltose corn syrup, high fructose corn syrup, and mixtures thereof;

about 15-25 wt. % of the shortening composition as in any one of claim 1;

about 10-25 wt. % water;

at least one emulsifier;

at least one starch; and

at least one gum.

14. A ready-to-spread (RTS) frosting comprising:

about 35-45 wt. % of at least one sugar alcohol;

about 20-30 wt. % of at least one bulking agent;

about 0.05-0.10 wt. % of at least one high intensity sweetener;

about 15-25 wt. % of the shortening composition as in any one of claim 1; and

about 5-10 wt. % water.

What is claimed is:

1. A shortening composition comprising:
at least 73 wt. % of a first component including (i) a non-hydrogenated, non-interesterified vegetable oil, (ii) a non-hydrogenated, non-interesterified palm stearin, and (iii) mixtures thereof;
at least 15 wt. % of a second component including a non-hydrogenated, non-interesterified vegetable oil having less than about 17% total saturated fatty acids; and
at least one emulsifier.

2. The shortening composition of claim 1, wherein the shortening composition includes about 73-81 wt. % of the first component.

3. The shortening composition of claim 1, wherein the shortening composition includes about 19-21 wt. % of the second component.

4. The shortening composition of claim 1, wherein the shortening composition includes about 43-50 wt. % palmitic acid, stearic acid, and mixtures thereof.

5. The shortening composition of claim 4, wherein the shortening composition includes about 37-41 wt. % palmitic acid and about 6-7 wt. % stearic acid.

6. The shortening composition of claim 4, wherein the shortening composition includes about 39-43 wt. % palmitic acid and about 6-7 wt. % stearic acid.

7. The shortening composition of claim 1, wherein the shortening composition includes about 45-52 wt. % oleic acid, linoleic add, and mixtures thereof.

8. The shortening composition of claim 7, wherein the shortening composition includes about 30-32 wt. % oleic acid and about 15-19 wt, % linoleic, acid.

9. The shortening composition of claim 7, wherein the shortening composition includes about 38-41 wt. % oleic acid and about 9-11 wt. % linoleic acid.

10. A shortening composition of claim 1, wherein the shortening composition includes non-hydrogenated, non-interesterified fats having about 37-43 wt. % palmitic acid, about 6-7 wt. % stearic acid, about 30-41 wt, oleic acid, and about 919 wt. % linolic acid.

11. A shortening composition of claim 1, wherein the shortening composition includes non-hydrogenated, non-interesterified fats having about 39-43 wt. % palmitic acid, about 6-7 wt. % stearic acid, about 30-32 wt. % oleic acid, and about 15-19 wt. % linoleic acid.

12. The shortening composition of claim 1, wherein the shortening composition has a Solid Fat Content (SFC) profile as measured according to AOCS CD 16b-93 of from about 47-53% solids at 10° C., and about 28-32% solids at 20° C., and about 9-11% solids at 40° C.

13. The shortening composition of claim 12, wherein the shortening composition has a Solid Fat Content (SFC) profile as measured according to AOCS CD 16b-93 of from about 50% solids at 10° C., and about 30% solids at 20° C. and about 10% solids at 40° C.

14. Ile shortening composition of claim 1, wherein the shortening composition includes less than 0.5 wt. % trans fatty acids.

15. A ready-to-spread (RTS) frosting comprising:
about 60-70 wt. % of at least one sweetener selected from the group consisting of sugar, powdered sugar, high maltose corn syrup, high fructose corn syrup, and mixtures thereof;
about 15-25 wt. % of a shortening composition, wherein the shortening composition includes at least 73 wt. % of a first component including (i) a non-hydrogenated, non-interesterified fled vegetable oil, (ii) a non-hydrogenated, non-interesterified palm stearin, and (ii) mixtures thereof, at least 15 wt, % of a second component including a non-hydrogenated, non-interesterified vegetable of having less than 17% total saturated fatty acids, and at least one emulsifier;
about 10-25 wt. % water:
at least one emulsifier;
at least one starch; and
at least one gum.

16. The frosting of claim 15, wherein the frosting includes less than 0.5 wt. % trans fatty acids.

17. The frosting of claim 15, wherein the shortening composition includes non-hydrogenated, non-interesterified fats having about 37-43 wt, % palmitic acid, about 6-7 wt, % stearic acid, about 30-41 wt. % oleic acid, and about 9-19 wt. % linoleic acid.

18. A ready-to-spread (RTS) frosting comprising:
about 35-45 wt. % of at least one sugar alcohol;
about 20-30 wt. % of at least one bulking agent;
about 0.05-0.10 wt. % of at least one high intensity sweetener;
about 15-25 wt. % of a shortening composition, wherein the shortening composition includes at least 73 wt, of a first component including (i) a non-hydrogenated, non-interesterified vegetable oil, (ii) a non-hydrogenated, non-interesterified palm stearin, and (iii) mixtures thereof, at least 15 wt % of a second component including a non-hydrogenated, non-interesterified vegetable oil having less than 17′1.1) total saturated tauv acids, and at least one emulsifier; and
about 5-10 wt. % water.

19. The frosting of claim 18, wherein the frosting includes less than 0.5 wt, % trans fatty acids.

20. The frosting of claim 18, whereat the shortening composition includes non-hydrogenated, non-interesterified fats having about 37-43 wt, palmitic acid, about 6-7 wt. % stearic acid, about 30-41 wt. % oleic acid, and about 9-19 wt. % linoleic acid.
